(19) United States
(12) Patent Application Publication
(10) Pub. No.: US 2010/0177100 A1
(43) Pub. Date: Jul. 15, 2010

(54) SYSTEM AND METHOD FOR CUSTOMIZED DISPLAY OF PHYSIOLOGICAL PARAMETERS

(76) Inventors: Tony Carnes, Gainesville, FL (US); Arik Anderson, Birmingham, MI (US); Bryan Burke, Birmingham, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/632,200

(22) Filed: Dec. 7, 2009

Related U.S. Application Data
(60) Provisional application No. 61/143,672, filed on Jan. 9, 2009.
(60) Provisional application No. 61/143,709, filed on Jan. 9, 2009.
(60) Provisional application No. 61/143,797, filed on Jan. 11, 2009.
(60) Provisional application No. 61/167,032, filed on Apr. 6, 2009.
(60) Provisional application No. 61/221,235, filed on Jun. 29, 2009.

(51) Int. Cl. G06T 11/20; G08B 23/00

(52) U.S. Cl. 345/440; 340/573.1

(57) ABSTRACT

A system includes a data repository on a bedside device, a networked device, or both, configured to receive at least one physiological parameter from each of a plurality of sources in a machine-dependent format and convert each physiological parameter received from the machine-dependent format into a machine-independent format. The bedside device is configured to display a graphical representation of at least one of the physiological parameters. The bedside device includes a graphical user interface configured to receive inputs from a user and customize the display of the physiological parameter based upon the inputs received from the user.

### CROSS-REFERENCE TO RELATED APPLICATIONS

This patent application claims priority to U.S. Ser. No. 61/143,672 filed on Jan. 9, 2009, U.S. Ser. No. 61/143,709 filed on Jan. 9, 2009, U.S. Ser. No. 61/143,797 filed on Jan. 11, 2009, U.S. Ser. No. 61/167,032 filed on Apr. 6, 2009, and U.S. Ser. No. 61/221,235 filed on Jun. 29, 2009, the contents of which are hereby incorporated by reference.

### BACKGROUND

Patient care is directly affected by a clinician's ability to understand available clinical parameters. The information that a clinician uses to arrive at a correct diagnosis can come from different sources such as user-entered parameters, laboratory results, and data from machines attached to the patient. Traditionally, some portion of this data is recorded at intervals in a tabular format. A clinician reviews this tabular format and determines whether the chosen treatment regimen is effective. However, reviewing the data in this manner may present various difficulties inhibiting a clinician's ability to treat the patient effectively. For example, it may be difficult for the clinician to make certain characterizations of the data because of insufficient granularity of data or the way the data is presented. Accordingly, a system is needed that allows for capture of data at more frequent intervals and that also allows the clinician to customize the way the information is presented.

### BRIEF DESCRIPTION OF THE DRAWINGS

FIG. 1 illustrates an exemplary system diagram of an integration system;

FIG. 2 illustrates an exemplary integration system that may be used to integrate physiological information;

FIG. 3 illustrates an exemplary graphical user interface that may be used with a bedside device;

FIG. 4 illustrates an exemplary graphical user interface that may be used with the bedside device that allows the user to customize the display of the physiological parameters;

FIG. 5 illustrates an exemplary multi-parameter graph;

FIG. 6 illustrates an exemplary graphical user interface that allows the user to generate templates to customize the display of the physiological parameters;

FIG. 7 illustrates an exemplary flowchart of a method of displaying the physiological parameters on the bedside device; and

FIG. 8 illustrates an exemplary flowchart of a method of generating the derived parameter from one or more physiological parameters received by the bedside device.

### DETAILED DESCRIPTION

A system allows a user to customize display of physiological parameters. The system includes a bedside device configured to receive at least one physiological parameter in a machine-dependent format, and convert the physiological parameter from the machine-dependent format to a machine-independent format. A presentation device is in communication with the bedside device and configured to display a graphical representation of at least one of the physiological parameters. The bedside device includes a graphical user interface configured to receive inputs from the user and customize the display of one or more physiological parameters based upon the inputs received from the user.

For example, the graphical user interface may allow the user to generate derived parameters by adding parameters, operators, constants, etc. to a formula field and applying the formula as defined by the user. The graphical user interface may further allow the user to customize the display of the physiological parameters by allowing the user to drag and drop parameters into a list of parameters to display. When viewing the parameters, the graphical user interface may be configured to allow the user to zoom in and out of various portions of the displayed parameters.

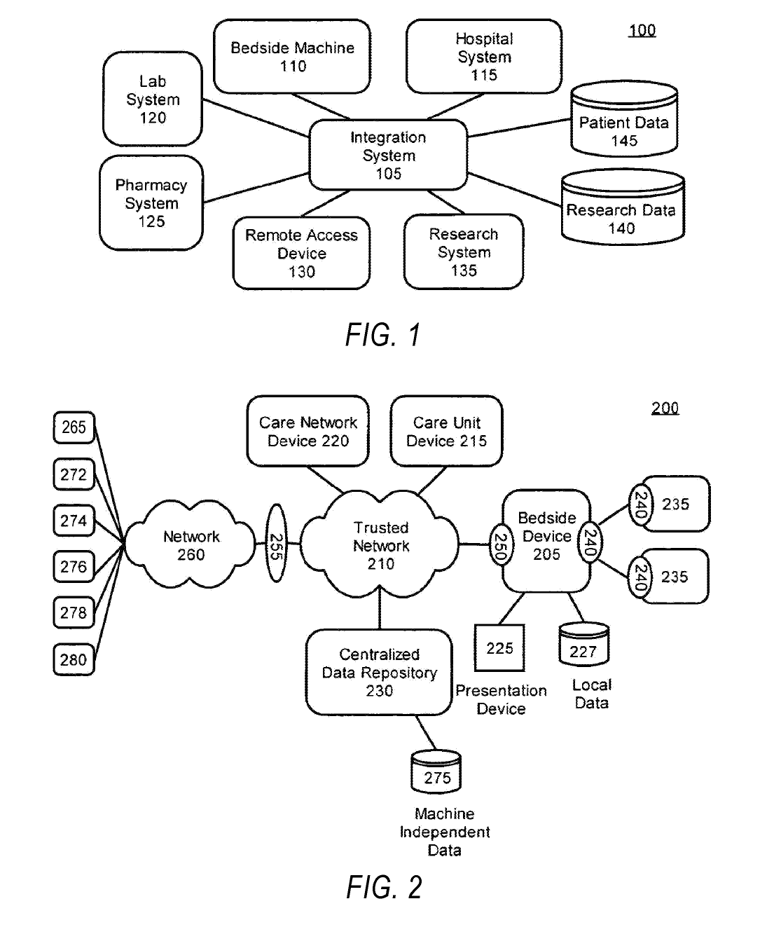

FIG. 1 is an exemplary diagram of a system 100 having an integration system 105 configured to integrate information from a plurality of sources. In addition to the integration system 105, the system 100 may include one or more of a bedside machine 110, a hospital information system 115, a laboratory information system 120, a pharmacy information system 125, a remote access device 130, and a research information system 135. The integration system 105 may be configured to receive information, including physiological information, from multiple sources, transform the information into data elements formatted according to a database schema, and convey these data elements to a variety of customized applications.

In one exemplary implementation, the integration system 105 may store patient information for a particular hospital within one or more data stores, such as a research data store 140 and a patient data store 145. By using different data stores, privacy considerations can be handled automatically without extensive human intervention and/or costs. The various data stores of the integration system 105 can include data from a multiplicity of different databases that are continuously or periodically synchronized with one another. Each of these databases can utilize the same or different information structures. When diverse information structures are included within the integration system 105, a data warehouse may be used to reconcile differences among the data elements.

The bedside machine 110 may be a sensor of physiologic data that can determine one or more parameters relating to the health of a patient (e.g., physiological parameters). The bedside machine 110 may include a blood gas monitor, an infusion pump, a physiological monitor, a pulse oximeter, a flowmeter, a ventilator, an automated patient care bed, a thermocouple probe, and the like. The bedside machine 110 may also include a data port for electronically conveying the physiologic information to connected computing devices. The data port may communicate via a physically connected cable or through a wireless transmission means, such as radio frequency. In one exemplary approach, the bedside machine 110 may be integrated with other bedside machines, and/or may be a stand-alone device. The bedside machine 110 may be any one of a plurality of devices configured to detect physiological parameters for patients, as may be located in a care taking facility such as an intensive care unit (ICU). Further, multiple bedside machines 110 that monitor a patient can be connected to the integration system 105. Physiologic data from the multiple monitors may be simultaneously displayed on a single presentation device within the integration system 105.

The hospital information system 115 may be used by a health care provider and contain patient and staff information. The hospital information system 115 may include, for example, patient medical records, a reference table between treating physicians and patients, patient contact information, physician contact information, and patient medical annotations such as allergies, blood type, donor status, and other medical attributes. The hospital information may also contain information concerning employees working specified shifts, on-call physicians, and alternative treating physicians for particular patients.

The laboratory information system 120 may be used by a medical laboratory. The laboratory information system 120 may include information related to conducted tests, such as the date of a test, a patient identifier, a sample identifier, methodologies used, examiner information, test results, and other test annotations. A laboratory information system 120 may be integrated within another information system, such as the hospital information system 115 or may be configured to function autonomously. Further, the laboratory information system 120 may be a system limited to a particular laboratory, or may contain information from a multitude of laboratories located at the same or different (e.g., remote) locations.

The pharmacy information system 125 may be used to record patient prescription information. For example, the pharmacy information system 125 may contain the prescribed item, a date for a prescription, prescription strength, prescription dosage, prescribing physician, patient, number of refills, known drug side effects and warnings, and the like. The pharmacy information system 125 may be an integrated system containing information from many different pharmacies or restricted to a particular pharmacy, such as one within a hospital or treating facility.

The remote access device 130 may include any device communicatively linked to the integration system 105. For example, the remote access device 130 may be a physician's home computer linked via the Internet to the integration system 105. In another example, the remote access device 130 may be a data tablet wirelessly connected to the integration system 105. Additionally, the remote access device 130 may include a warning mechanism such as an auditory or visual alarm that may be triggered upon the receipt of a specified signal from the integration system 105.

The research information system 135 may contain data relating to clinical research involving physiologic data. While the research information system 135 may be dedicated to a single research facility, the research information system 135 may also contain multiple different geographically separated research institutions and/or organizations. For example, the research information system 135 may be a general university system that includes multiple connected medical universities located within one or more countries.

FIG. 2 illustrates an exemplary integration system 200 that may be used to integrate physiological information. The integration system 200 may include the bedside device 205, a trusted network 210, a care unit device 215, a care network device 220, a centralized data repository 230, and one or more bedside machines 235. The bedside machines 235 may include a sensor of physiologic data that may be configured to determine one or more parameters relating to the health of a patient. Each bedside machine 235 may include a data port 240. If the data port 240 is not installed at the time of manufacture, the bedside machine 235 may be retrofitted to include the data port 240. The data ports 240 may convey a data stream between the bedside machine 235 and the bedside device 205. The data port 240 may include any serial or parallel connection such as FireWire, USB (Universal Serial Bus), Centronics, an infra-red port, and the like. For example, the data port 240 may be an RS-232 connector that may be configured to convey information as a serial data stream.

The bedside device 205 may include a computing device capable of managing and presenting physiologic data at a bedside location. For example, the bedside device 205 may include a computer that accesses and organizes patient data. Alternatively, the bedside device 205 may include a communication portal that reconciles data streams between local equipment and a network 260. Multiple bedside devices may be utilized within a system, where each bedside devices may be configured to manage data for one or more patient beds. The bedside device 205 may handle a variety of different peripheral devices such as one or more bedside machines 235, a local data store 227, and a presentation device 225. Further, the bedside device 205 may include a data port 240 that is compatible with the data port 240 of the bedside machine 235. The bedside device 205 may also include device drivers to convert received data streams to a format independent of any particular bedside machine 235.

The local data store 227 may be any type of information storage device compatible with the bedside device 205, such as magnetic, optical, and/or electronic storage devices. By storing data locally within the local data store 227, the system may provide integrated data even when network 260 difficulties prevent the bedside device 205 from accessing the trusted network 210. The local data store 227 can store data from the bedside machine 235, as well as data from other information sources connected to the trusted network 210.

The presentation device 225 may be any device capable of presenting data stored within the local data store 227 to a user. The presentation device 225 may include, but is not limited to, a computer monitor, a touch screen, a printer, a fax machine, and/or an audio output device. The bedside device 205 may communicate with the trusted network 210 via a network port 250.

The bedside device 205 may also contain a driver for each bedside machine 235 connected thereto. This driver may be used to translate the data stream into content that may be related across a network 260. Each driver may have knowledge of a corresponding type of bedside machine 235. The device driver may interpret device specific protocols for data streams of the bedside machine 235. Additionally, different drivers may be used to interpret data streams sent from different bedside machines 235.

The trusted network 210 may be an intranet including communicatively linked caregiver computing assets. Some of the devices within the trusted network 210 may be isolated from other communicatively linked devices using network firewalls 255. Within the trusted network 210, physical and logical security precautions may be taken to impede unauthorized information access. A few of the caregiver computing assets with which the trusted network 210 may link include the bedside device 205, the care unit device, the care network device 220, the centralized data repository 230, and one or more other networks 260.

The care unit device 215 may include a computing device that maintains information on a unit level for a health institution. For example, the care unit device 215 may include personal information for various shifts, bed availability information, an inventory of bedside machines 235, operating room schedules for a given care unit, and contact information for patients, physicians, and staff. In one exemplary approach, the care unit device 215 may include physiologic information derived from various bedside devices 205 within a care unit. For example, the care unit device 215 may be located within a nursing station and may include summary information for all bedside machines 235 in use within the care unit. Further, the care unit device 215 may provide warnings whenever parameters for a given bedside device 205 exceed predetermined limits. The care unit device 215 may also present reminder information detailing when particular patients require assistance, such as needing fluids replaced, pills dispensed, and/or sanitary assistance.

The care network device 220 may maintain information on the care giving network 260 level, therein providing inter-unit coordination. The care network device 220 may help assure that when patients are transferred from one bedspace or care unit to another, all treatment information is properly transferred. For example, if a patient is moved from one bed to another, the care network device 220 may assure the appropriate information is presented within the bedside device 205 associated with the new bed. Additionally, the care network device may display warnings when the same patient is simultaneously assigned to multiple beds or when a current patient that has not been discharged is not assigned to any bed. Moreover, the care network device 220 may assist in patient management for a hospital, hospital system, or health care network. The care network device 220 may also include summary data for the various units that make up a health care network.

The centralized data repository 230 may be part of the bedside device 205, or as illustrated in FIG. 1, in communication with the bedside device 205 via trusted network 210. The centralized data repository 230, the bedside device 205, or both may perform data reconciliation between two or more diverse sources. For example, the centralized data repository 230 may synchronize patient data from a laboratory database with similar information contained within a database of a hospital information system. In another exemplary approach, the bedside device 205 may convert information presented in a machine specific format from one of the bedside machines 235 into a standardized schema. Patient information received by the centralized data repository 230 may be converted to adhere to defined data standards and stored locally in a machine-independent format in local data store 227.

To perform these data conversions, tables that cross-reference machine or database specific data to standardized data may be stored within a machine-specific data store or the local data store 227. Each supported data source, such as a particular bedside machine 235, may have appropriate cross reference tables for data conversion stored within the machine-specific data store or the local data store 227. For example, one bedside machine 235 may store pulse rate as a floating-point variable called “RATE”, while the data standard can record pulse rate as an integer variable called “PULSE”. In this example, data stored within the machine specific data store or local data store 227 may detail that “RATE” equals “PULSE”. The centralized data repository 230 may also convert the content within the variables from a floating-point value to an integer. Using the machine-specific data store or local data store 227, information may be conveyed to and from various sources within the trusted network 210 without concern for data formatting peculiarities.

The centralized data repository 230 may perform real-time and/or near real-time data conversions. Accordingly, information from the bedside machine 235 may be converted by the centralized data repository 230 to a data standard. The standardized data may be conveyed to the bedside device 205 for display. Performance considerations for real-time conversions may be carried out by the bedside device 205 and include some of the converting functions carried out within the centralized data repository 230. Functions and/or conversion information may be transmitted to the bedside device 205 from the centralized data repository 230. In one exemplary approach, each bedside machine 235 may perform the functionality attributed to the centralized data repository 230. In such an approach, the bedside machine 235 may monitor and translate presented physiological data from multiple bedside machines 235 without the assistance of external networked elements.

The trusted network 210 may be communicatively linked to a network 260 through a gateway 255. The gateway 255 may provide security measures, such as passwords and encryption heuristics, to assure that only authorized parties can access the trusted network 210. Various sources that may access the trusted network 210 include, for example, a laboratory information system 265, a hospital information system 272, a pharmacy information system 274, a researcher or clinical research facility 276, a physician 278, and an administrator 280.

In operation, a patient may be monitored by the bedside machine 235. A data stream, such as a byte-level data stream, may be sent from the bedside machine 235 to the bedside device 205. When the data stream is conveyed at the byte-level, the data port 240 may function as an interface between data terminal equipment (e.g., the bedside machine 235) and data communication equipment (e.g., the bedside device 205), which may employ binary data interchange to convey information. A device driver within the bedside device 205 may facilitate communications with the bedside machine 235.

For example, the bedside machine 235 may be used for monitoring blood pressure by generating a data stream having discrete 20 byte segments, where the first 4 bytes in each byte segment identify the machine, the next 6 bytes contain a timing parameter, the next 5 bytes a systolic value, and the final 5 bytes a diastolic value. The device driver for the bedside machine 235 may be configured to correctly interpret the segments data stream for the machine using on-board software. In one exemplary illustration, a different manufacturer of a different bedside machine 235 for blood pressure monitoring may segment the data stream into 30 byte segments. The different bedside machine 235 may have a different driver associated with it. Both blood pressure machines described may be alternatively used within the system.

Once data stream information has been properly segmented, the segmented information may be converted into a standard format at the bedside device 205 or by the centralized data repository 230. The converted information may be stored in the local data store 227, and in one exemplary approach, if part of a network, the converted information may further be relayed from the bedside device 205 to the trusted network 210 via the network port 250 and copied into the machine independent data store 275. Information may also be provided by other data sources such as the laboratory, the hospital information system, and the pharmacy. The data from other data sources may be integrated within the bedside device 205. Further integrated information may be accessed externally from remote computing devices. For example, a physician on-call may access the bedside device 205 information or centralized data repository 230 information via the Internet, even when that doctor is offsite.

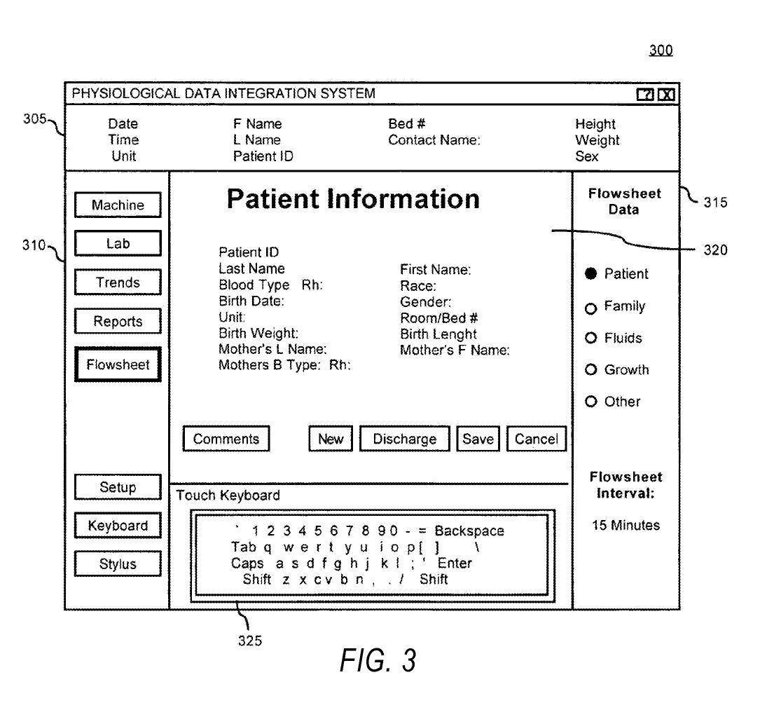

FIG. 3 illustrates an exemplary graphical user interface 300 for a bedside device 205. The graphical user interface 300 may include a patient overview section 305, an application selection section 310, a content selection section 315, a content section 320, and an input section 325. The patient overview section 305 may include general patient information such as date, unit, name, bed, height, weight, sex, and a patient identifier. In one exemplary approach, additional patient background information, such as patient history, may be accessed by clicking an appropriate button located within this section. The information within the patient overview section 305 may be derived from a number of sources including a hospital information system.

The application selection section 310 may allow for the selection of one or more integrated applications. The application selection section 310 may include, but is not limited to, applications for bedside machines 235, laboratories, trends, reports, and patient flowsheets. In one example, the selection made within the application selection section 310 may be linked to the content selection section 315 where a selection made within the application selection section 310 may cause different options to appear within the content selection section 315.

In another exemplary approach, a selection within the application selection section 310 may open a view within which the selected application may appear. This window may be an emulation window showing the content of a networked application. For example, the selection of the machine button within the application selection section 310 may cause a window to appear emulating the screen of a selected machine, such as an infusion pump or a pulse oximeter. Such an emulation screen may be useful for physicians, who are familiar with standard machine readouts, to view patient data, whether the physician is at the bedside or accessing the system from a remote location.

The content selection section 315 may allow one or more selections to be made which determine the content displayed within the content section 320. The content selection section 315 may display a flowsheet interval, such as 15 minutes or another predetermined or selectable time interval, which represents the time frame in which new flowsheet data should be displayed. The flowsheet interval may be selected by the treating physician depending on the needs of the patient.

The content section 320 may display selected patient information that may be provided automatically to the bedside device 205 from one or more sources or manually by the user. The content section 320 may present patient information including, but not limited to, patient identifier, last name, blood type, birth date, unit, mother's name, gender, room, and bed. The patient information displayed within the content section 320 may vary depending on patient age, type, and care unit. For example, the mother's name and blood type may appear within the content information section whenever the patient is a newborn.

The input section 325 may be available whenever the graphical user interface 300 appears within systems with touch screen capabilities or other input means. Thus, although peripheral keyboards may be used, such devices are not necessary for operation. Alternatively, the graphical user interface 300 may appear within a personal data assistant (PDA) communicatively linked to a bedside device 205. Since a bedside device 205 may be located within a patient's vicinity, touch screens, such as the one depicted in the input section 325, represent one minimally intrusive way to provide an input to the bedside device 205. It should be noted that any input device, such as a stylus, an external keyboard, and/or a microphone for speech input, may be used.

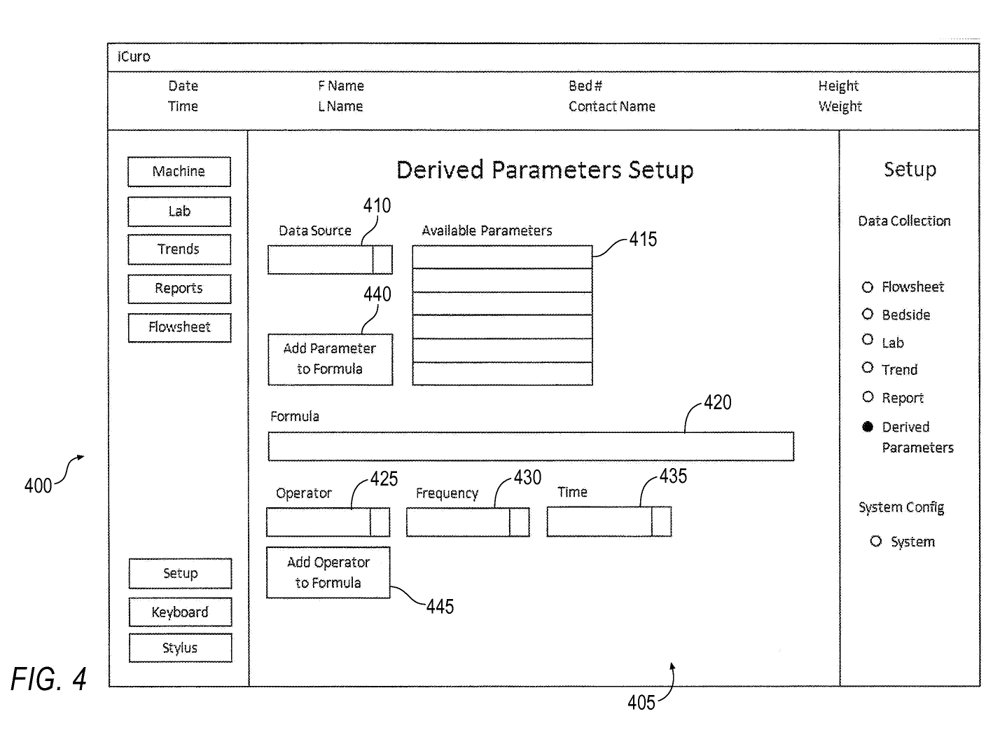

FIG. 4 illustrates an exemplary graphical user interface 400 that allows a clinician to customize how the physiological parameters are displayed on the presentation device 225 of the bedside device 205. In one exemplary approach, the content section 405 of the graphical user interface 400 illustrated in FIG. 4 may include, but is not limited to, a data source selection field 410, a list of available parameters 415 for the selected data source, a formula field 420, an operator field 425, a frequency field 430, a time field 435, and one or more buttons such as an add parameter button 440 and add operator button 445.

The data source selection field 410 may be populated with the names of one or more sources such as the bedside machines 235 or the laboratory information system 265, the hospital information system 272, the pharmacy information system 274, the research information system or clinical research facility 276, a doctor or other clinician 278, and/or an administrator 280.

The list of available parameters 415 may be automatically populated based on the data source selected from the data source selection field 410.

The operator field 425 may store one or more heuristic operators, including but not limited to, an addition operator represented by “+”, an assignment operator represented by “=”, a division operator represented by “/”, an integral operator represented by “∫”, a logical AND operator represented by “&&”, a logical equality operator represented by “==”, a logical inequality operator represented by “!=”, a logical NOT operator represented by “!”, a logical OR operator represented by “H”, a multiplication operator represented by “*”, a relational greater than or equal to operator represented by “>=”, a relational greater than operator represented by “>”, a relational less than or equal to operator represented by “<=”, a relational less than operator represented by “<”, a subtraction operator represented by “−”, and a summation operator represented by “s”. The operator field 425 may further include aggregating functions that may be selected by the user such as a maximum level, a minimum level, and an average level. These heuristic operators, functions, and symbolic representations are merely exemplary and not meant to be limiting. The operator field 425 may include any number of these or different operators and/or symbolic representations.

The frequency field 430 may present the user with the option of selecting a frequency at which to output the physiological parameters received from one or more of the sources.

The time field 435 may include one or more times or ranges of times that may be selected and applied to the formula in the formula field 420.

The add parameter button 440 may be used by the user to add one or more of the parameters displayed in the list of available parameters 415 to the formula field 420. Similarly, clicking or pressing the add operator button 445 may add one or more of the operators selected in the operator field 425 to the formula field 420.

The bedside device 205 may be configured to apply the formula in the formula field 420 to the physiological parameters received by one or more sources to generate a derived parameter and display the derived physiological parameter on the presentation device 225. An example of the derived parameter using temporal and heuristic manipulation of data collected from multiple sources is the Autoregulation Correlation Coefficient (ACC). ACC is a Pearson product moment correlation coefficient, r, which is a value calculated by comparing multiple readings of blood pressure, x, with multiple readings of blood flow, y, obtained over a period of time. Cerebral regional oxygen saturation, rSO₂ is a surrogate for blood flow. The formula may be as follows in Equation 1:

$$r = \frac{\sum ( x - \overline{x} ) ( y - \overline{y} )}{\sqrt{\sum {( x - \overline{x} )}^{2} \sum {( y - \overline{y} )}^{2}}} \qquad ( Equation 1 )$$

In one exemplary approach, where there is a strong ACC correlation, the patient may have pressure passive circulating indicating the loss of autoregulation. Where there is no ACC correlation, healthy autoregulation is taking place. Consequently, the ability to derive the ACC value is indicative in assessing a patient's state of health. ACC correlation is just one example and other correlations may be made between the various physiological parameters received.

Using the presentation device 225, the bedside device 205 may present a graphical representation of one or more of the physiological parameters received from the source or one or more of the derived physiological parameters customized by the clinician.

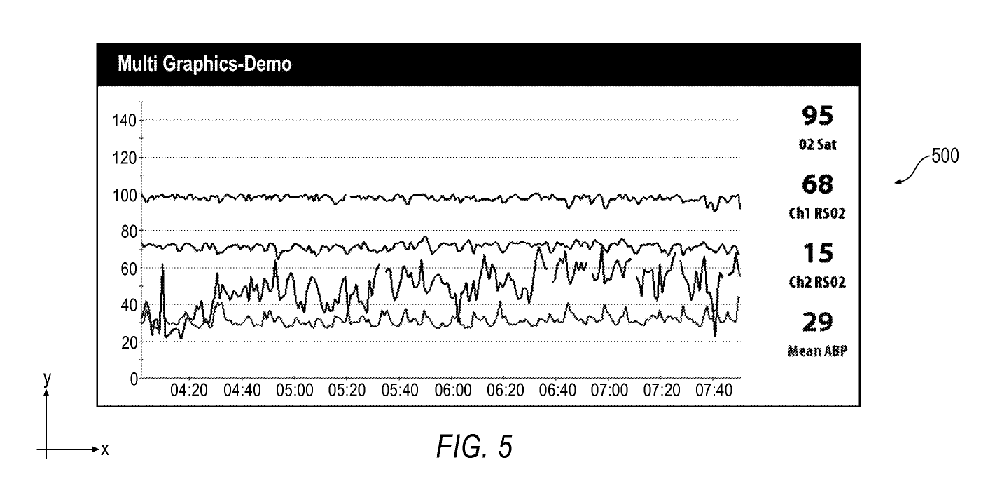

FIG. 5 illustrates an exemplary multi-source graph 500 displaying graphical representations of physiological parameters from four sources. The multi-source graph 500 of FIG. 5 includes two axes (e.g., an x-axis and a y-axis) perpendicular to one another. The x-axis may represent time while the y-axis may represent a machine-independent value. Although any number of physiological parameters may be presented, machine-independent graphical representations of oxygen saturation (O₂ Sat), regional oxygen saturation for two oximeters (Ch1 RS0₂ and Ch2 RS0₂), and mean arterial blood pressure (Mean ABP) are illustrated in the graph 500 of FIG. 5. Alternatively, the graph 500 may display a physiological parameter or derived parameter from a single or multiple sources.

To easily identify important data points on the displayed physiological parameters, the presentation device 225 may display one or more event markers simultaneously with the physiological parameters. The event marker may persistently and uniquely identify an event in time across one or more collections of patient date, including physiological parameters. The event marker may include an event time and/or a collection of one or more event types. The event time is the time or timeframe at which the event mark occurred. The event type may be one or more codes from a predefined enumerated list or a newly or previously created user defined code. Event markers may be color or symbol-coded to convey frequency or occurrence, identify cautionary items, identify organ systems, or increase visibility of specified or created events. The event markers may further or alternatively be based on one or more time of the n^{th} occurrence, level of importance or priority, timeframe of more than one occurrence, and/or any pattern of occurrence including user defined patterns. When the event occurs, the event marker may be displayed simultaneously with the physiological parameter and indicate to the user when the event took place. In addition, the event marker may trigger an alarm as discussed in greater detail below.

Creation of the event marker may occur through manual user entry or automatically based on predefined criteria. Manual or automated marking of an event may occur during (e.g., in real time) or after collection of data being marked (e.g., post-processing). Manual event markers may be created by selecting at least one patient data point and one predefined or user-created code. The criteria entered by the user may be defined through heuristics or logical operations on one or more points of data, which may come from multiple sources, be derived by applying a formula to one or more physiological parameters, or be a constant value. The user may input the criteria into the graphical user interface.

An event marker may be different than an alarm in that the occurrence of the event marker may be perpetuated and associated with the marked collection of data, whereas the alarm may stop after the condition that precipitated the alarm ceases to exist or the alarm is cleared by the user. Creation of and searching for event markers may enable the clinician or other medical health professional to quickly segregate, access, and respond to data of interest from the vast volume of information collected during patient monitoring.

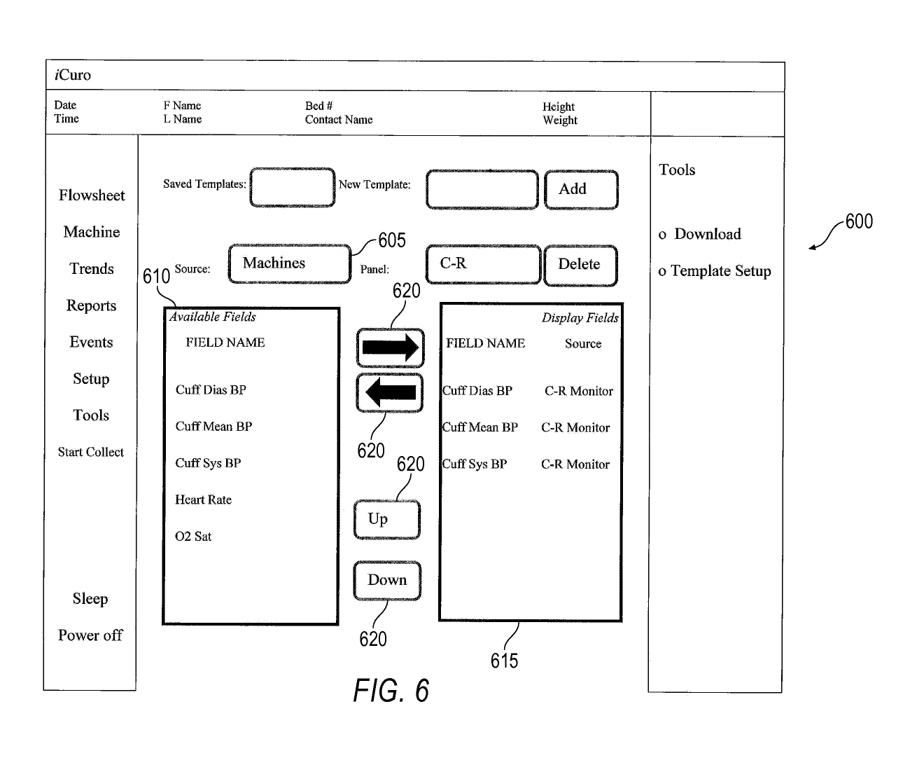

FIG. 6 illustrates another exemplary graphical user interface 600 that allows the clinician to create templates that include physiological parameters from multiple sources. The exemplary graphical user interface 600 may provide the user with a source selection field 605, a list of available fields 610, a list of display fields 615, and navigation buttons 620.

The source selection field 605 may allow the user to input the desired source. In response to the user pressing or clicking on the source selection field 605, a list of available sources may be displayed, providing the user with an option to select one or more of the sources.

The list of available fields 610 may include a list of physiological parameters received from the source selected by the user. The list of available fields 610 may be automatically populated by the bedside device 205 in response to the user selecting one or more of the sources.

The list of display fields 615 may include the physiological parameters to display on the presentation device 225. In one exemplary approach, only those fields in the list of display fields 615 may be displayed. The bedside device 205 may further allow the user to select the presentation device 225 on which to display the physiological parameter if multiple presentation devices 225 are connected to the bedside device 205. The user may be able to identify one presentation device 225 as a default or primary presentation device 225.

The navigation buttons 620 may allow the user to add or remove physiological parameters from the list of available fields 610 to or from the list of display fields 615, or change the priority of the physiological parameters to display.

The user may also be able to save and/or name the template using an add button and a text field. Moreover, the graphical user interface 600 may provide the user with the option of selecting one or more previously created or saved templates.

Although graphical user interfaces are illustrated in FIGS. 3, 4, and 6, the bedside device 205 may include a text-based user interface instead.

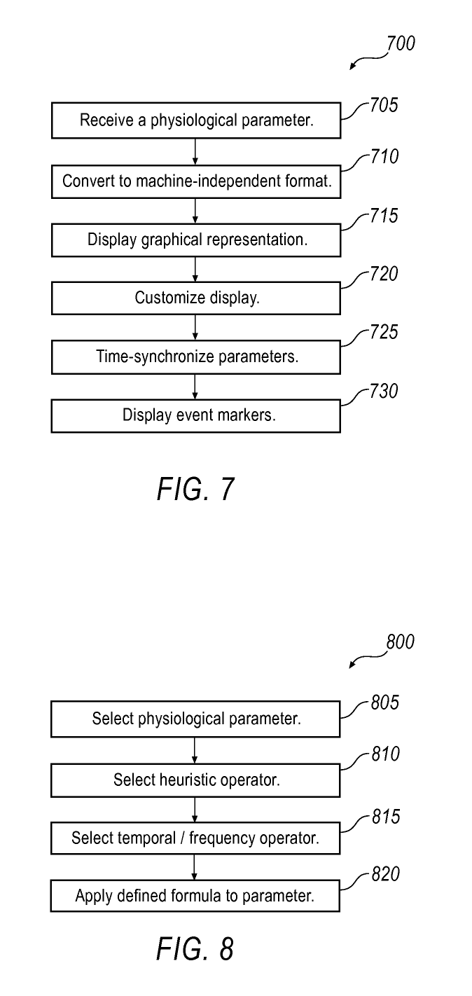

Exemplary implementations of the bedside device 205 will now be described. FIG. 7 illustrates an exemplary method 700 that includes a step 705 of receiving at least one physiological parameter from each of a plurality of sources at a database in a machine-dependent format. The plurality of sources may include one or more bedside machines 235, the laboratory information system 265, the hospital information system 272, the pharmacy information system 274, a research information system or clinical research facility 276, the doctor 278, and/or the administrator 280. The database may include the centralized data repository 230 storing machine specific data in the machine independent format.

Step 710 may include converting each physiological parameter received from the machine-dependent format into a machine-independent format. For example, the centralized data repository 230, which may be part of or networked with the bedside device 205, may include a heuristic for converting the data received from each of the sources into the machine-independent format. Upon receipt of the physiological parameters in the machine-dependent format, the centralized data repository 230 may automatically convert the physiological parameters into the machine-independent format by applying the heuristic. The centralized data repository 230 may store the physiological parameter in the machine-independent format in the machine independent data store 275. Alternatively, the bedside device 205 may store the physiological parameter in the machine-independent format in the local data store 227, and if networked, forward the parameter in the machine-independent format to the machine independent data store 275 via the trusted network 210.

Step 715 may include displaying a graphical representation of at least one of the physiological parameters on the bedside device 205. For example, the physiological parameters may be displayed using the presentation device 225. Any number of graphs may be displayed on the presentation device 225, and each graph may include any number of physiological parameters.

Step 720 may include customizing the display of the physiological parameter based upon inputs received by the user using the graphical user interface such as the graphical user interface illustrated in FIG. 4 or 6. The user may interact with the bedside device 205 via a touch screen or input device, such as a keyboard or mouse. The bedside device 205 may be configured to adjust the output of one or more of the physiological parameters to the presentation device 225 based on the inputs received from the user. For example, the user may select at least one physiological parameter to display on the presentation device 225 by dragging and dropping one or more of the physiological parameters from one portion of the graphical user interface, such as the list of available fields 610 (see FIG. 6) to another portion of the graphical user interface such as the list of display fields 615 (see FIG. 6).

In addition, the bedside device 205 may be configured to allow the user to assign an importance or priority to one or more of the physiological parameters or select the number of physiological parameters to display, and display the physiological parameters on the presentation device 225 accordingly. For example, the user may be able to change the priority or order of importance of the physiological parameters by moving the physiological parameter to a desired location on the graphical user interface by placing the more important fields near the top of the display field list (e.g., see FIG. 6) and the less important fields near the bottom of the display field list using the navigation buttons or by dragging and dropping the physiological parameters into the desired location on the graphical user interface. Similarly, the bedside device 205 may allow the user to remove one or more physiological parameters from the display field list by dragging the physiological parameter from the list and dropping the physiological parameter into an, for example, an electronic trashcan or recycle bin. Alternatively, the user may remove the physiological parameter by clicking a close button on a header of the graph. Moreover, the bedside device 205 may allow the user to add one or more physiological parameters by selecting at least one available physiological parameter and dragging the selected parameter to the display field list, or by dragging the physiological parameter into a drop area of the graph.

The step 720 of customizing the display of the physiological parameters may include scaling at least one of the axes of the graph as presented on the presentation device 225 (e.g., see FIG. 5) in response to an input from the user. For example, the user may provide a minimum level, a maximum level, or both, for one or more of the parameters, and the bedside device 205 may scale the axes by adjusting either the x-axis or the y-axis to display the physiological parameter at least partially between the minimum and maximum level. Alternatively, the bedside device 205 may scale either or both of the x-axis and the y-axis by normalizing one of the physiological parameters to a percentage of change of the other physiological parameter. Instead of scaling based on level or percentage, the bedside device 205 may further be configured to allow the user to scale the output based on a desired output frequency.

Instead of or in addition to scaling the physiological parameters, the bedside device 205 may be configured to zoom in and/or zoom out on select portions of the graph based on user inputs. For example, the bedside device 205 may enlarge portions of the graph on the presentation device 225 for display to the user so that the user may view precise data points at specific times. Moreover, the bedside device 205 may be configured to reduce the size of the graph to allow the user to view trends in the data over time. This zooming feature may be in response to the user identifying a time range received by the bedside device 205. The presentation device 225 may be configured to display only the physiological parameters that occurred within the identified time range, which may give the user the appearance of zooming in or zooming out on the graph.

Step 725 may include time-synchronizing each of the physiological parameters displayed on the bedside device 205. For example, the bedside device 205 may be configured to time-synchronize each of the physiological parameters by accessing a database, such as the centralized data repository 230. The database may include one or more tables with information identifying the time at which the physiological parameter was recorded. The bedside device 205 may query one or more of the tables and synchronize the physiological parameters based on the time the physiological parameters were recorded. The user may be able to download a list of time-synchronized physiological parameters from one or more of the sources. Moreover, the bedside device 205 may be configured to export the time-synchronized data into multiple formats such as, but not limited to, a text file, a spreadsheet compatible format, or any other format suitable for later analysis by a computer, machine, or user. The output file generated may be communicated electronically and/or copied onto a removable medium such as a universal serial bus (USB) drive, compact disc, digital versatile disc, or any other portable or non-portable electronic device.

Step 730 may include displaying an event marker on the presentation device 225 simultaneously with the physiological parameter. The bedside device 205 may be configured to analyze each data point of each of the physiological parameters received and associate the data point with an event based upon predetermined circumstances indicating that the event has occurred. For example, the bedside device 205 may determine a value of the data point, the time at which the value occurred, a timeframe for which the value was above or below a predetermined level, etc. The bedside device 205 may further be configured to allow the user to associate a description with the event marker and display the description with the event marker in response to an action performed by the user. For example, the bedside device 205 may display the description in response to the user pressing or clicking the event marker or in response to the user hovering over the event marker with, for example, a pointer from a mouse. Also, the user may link the event marker with a particular patient using a patient identifier.

The event markers of step 735 may be based upon custom event markers defined by the user. For example, the bedside device 205 may be configured to receive attributes, logical operators, and/or constant values selected by the user. The attributes may include one or more of the physiological parameters, derived physiological parameters, specific data values related to one or more of the physiological parameters, a minimum or maximum amount of time or timeframe, a frequency of occurrence, time of the n^{th} occurrence, event type, user created code, level of importance or priority, timeframe of more than one occurrence, or any other pattern of occurrence, etc.

The event markers of step 735 may further be used to trigger an alarm. For example, the bedside device 205 may monitor the physiological parameters for one or more specific event markers and compare the event markers to predetermined alarm conditions. When the alarm condition occurs, the bedside device 205 may trigger the alarm by, for example, sending an email or text message to a clinician, or by activating a visual or audio signal.

FIG. 8 illustrates an exemplary method 800 of generating the derived parameter from one or more physiological parameters received by the bedside device 205 using, for example, the graphical user interface 400 illustrated in FIG. 4.

Step 805 may include selecting at least one physiological parameter from at least one of the plurality of sources. For example, the user may choose the source from the data source selection field 410 illustrated in FIG. 4, and pick one of the physiological parameters presented to the user in the list of available parameters 415 using the graphical user interface 400. The user may press the add parameter button 440, and in response, the bedside device 205 may input the physiological into the formula field 420.

Step 810 may include selecting the heuristic operator in response to input from the user. For example, the user may choose one or more operators from the operator field 425, and the bedside device 205 may be configured to input the selected operator into the formula field 420 upon the user pressing the add operator button 445.

Steps 805 and 810 may be repeated as necessary until the formula field 420 defines the desired relationship between one or more physiological parameters. Moreover, the bedside device 205 may allow the user, through the graphical user interface 400, to input constant values or any number of other values, parameters, or operators, into the formula field 420. This way, the formula may be customized by the user.

Step 815 may include selecting a temporal or frequency operator in response to an input from the user. In one exemplary illustration, the user may select a time from the time field 435 and/or a frequency from the frequency field 430. In response, the bedside device 205 may apply the time and/or frequency to the desired formula identified in the formula field 420.

The method 800 may conclude with a step 820 of applying the formula as defined by the formula field 420, and the derived physiological parameter is generated as a result. Once generated, the derived physiological parameter may be manipulated as described with regard to the method 700 illustrated in FIG. 7. For example, the derived parameter may be displayed on the presentation device 225 in various formats including, but not limited to, a tabular format and/or a graphical format. Also, the derived physiological parameter may be exported, for example, to a text file, in a spreadsheet compatible format, or a printer. Moreover, the derived parameter may be used to trigger an alarm when the derived parameter meets a predetermined condition. For example, the user may define the predetermined condition, and the bedside device 205 may continuously monitor the value of the derived parameter to determine of the predetermined condition has been met. If so, the beside device may be configured to trigger the alarm by, for example, sounding an audio alarm, displaying a visual alarm, or sending a text message or email to a clinician or other user. The alarm may also be triggered in response to event markers defined by the bedside device 205 or by the user.

In general, the computing systems and/or devices described herein may employ any of a number of well known computer operating systems, including, but by no means limited to, known versions and/or varieties of the Microsoft Windows® operating system, the Unix operating system (e.g., the Solaris® operating system distributed by Sun Microsystems of Menlo Park, Calif.), the AIX UNIX operating system distributed by International Business Machines of Armonk, N.Y., and the Linux operating system. Examples of computing devices include, without limitation, a computer workstation, a server, a desktop, notebook, laptop, or handheld computer, or some other known computing system and/or device.

Computing devices generally include computer-executable instructions, where the instructions may be executable by one or more computing devices such as those listed above. Computer-executable instructions may be compiled or interpreted from computer programs created using a variety of well known programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium (also referred to as a processor-readable medium) includes any tangible medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network or on the computing device. in any one or more of a variety of manners, as is known. A file system may be accessible from a computer operating system, and may include files stored in various formats. An RDBMS generally employs the known Structured Query Language (SQL) in addition to a language for creating, storing, editing, and executing stored procedures, such as the Procedural Language/Structured Query Language (PL/SQL) language mentioned above.

In some examples, system elements may be implemented as computer-readable instructions (e.g., software) on one or more computing devices (e.g., servers, personal computers, etc.), stored on computer readable media associated therewith (e.g., disks, memories, etc.).

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the invention is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

1. A method comprising:
receiving at least one physiological parameter from each of a plurality of sources in a machine-dependent format;
converting each physiological parameter received from the machine-dependent format into a machine-independent format;
displaying a graphical representation of at least one of the physiological parameters on a presentation device; and
customizing the display of the physiological parameter based upon an input received by a user through the graphical user interface.

2. A method as set forth in claim 1, wherein customizing the display of the physiological parameter includes selecting at least one physiological parameter to display on the presentation device in response to the input from the user.

3. A method as set forth in claim 2, wherein selecting at least one physiological parameter to display on the presentation device includes selecting the at least one physiological parameter in response to the user dragging and dropping the at least one of the physiological parameters from one portion of a graphical user interface to another portion of the graphical user interface.

4. A method as set forth in claim 1, wherein the graphical representation of the at least one physiological parameter includes a graph defined by at least two axes, and wherein customizing the display of the physiological parameter includes scaling of at least one of the axes in response to the input from the user.

5. A method as set forth in claim 1, wherein customizing the display of the physiological parameter includes:
zooming in on at least a portion of the display in response to the input received from the user; and
zooming out of at least a portion of the display in response to the input received from the user.

6. A method as set forth in claim 1, wherein customizing the display of the physiological parameter includes displaying an event marker simultaneously with the physiological parameter on the bedside device.

7. A method as set forth in claim 6, further comprising triggering at least one alarm based on the event marker.

8. A method as set forth in claim 6, wherein the event marker is displayed based on at least one of time or timeframe of occurrence, event type, user created code, time of the n^{th} occurrence, level of importance or priority, timeframe of more than one occurrence, and any pattern of occurrence.

9. A method as set forth in claim 1, further comprising transmitting at least one of the physiological parameters to the bedside device in the machine-dependent format.

10. A method as set forth in claim 1, further comprising time-synchronizing each of the physiological parameters displayed on the bedside device.

11. A method comprising:
selecting at least one physiological parameter from at least one of a plurality of sources;
selecting a heuristic operator in response to the input from a user;
inserting the selected physiological parameter and operator into a formula field to define a heuristic; and
applying the heuristic in the formula field to the selected physiological parameter to define a derived parameter.

12. A method as set forth in claim 11, further comprising:
selecting a temporal operator in response to the input from the user;
selecting a frequency operator in response to the input from the user; and
inserting at least one of the selected temporal operator and the selected frequency operator to the formula field such that at least one of the selected temporal operator and the selected frequency operator are included in the heuristic defined by the formula field.

13. A system comprising:
a bedside device configured to receive at least one physiological parameter in a machine-dependent format and convert one or more physiological parameters received from the machine-dependent format to a machine-independent format, said bedside device having a graphical user interface; and
a presentation device in communication with said bedside device and configured to display a graphical representation of at least one of the physiological parameters;
wherein said graphical user interface is configured to receive inputs from a user and customize the display of the physiological parameter based upon the inputs received from the user.

14. A system as set forth in claim 13, wherein said bedside device is configured to select at least one physiological parameter to display on said presentation device in response to the input from the user.

15. A system as set forth in claim 13, wherein said bedside device is configured by selecting at least one physiological parameter to display on the presentation device in response to the user dragging and dropping at least one of the physiological parameters from one portion of the graphical user interface to another portion of the graphical user interface.

16. A system as set forth in claim 13, wherein said presentation device is configured to display a graph defined on at least two axes and wherein said bedside device is configured to scale at least one of the axes in response to the input from the user.

17. A system as set forth in claim 13, wherein said presentation device is configured to zoom in on at least a portion of the display in response to the input received from the user and zoom out of at least a portion of the display in response to the input received from the user.

18. A system as set forth in claim 13, wherein said presentation device is configured to display an event marker simultaneously with the physiological parameter.

19. A system as set forth in claim 18, wherein said bedside device is configured to trigger at least one alarm based on the event marker.

20. A system as set forth in claim 18, wherein the event marker is displayed on said presentation device based on at least one of time or timeframe of occurrence, event type, user created code, time of the n^{th} occurrence, level of importance or priority, timeframe of more than one occurrence, and any pattern of occurrence.

21. A system as set forth in claim 13, wherein said bedside device is configured to time-synchronize each of the physiological parameters displayed on said presentation device.

22. A system as set forth in claim 13, further comprising a centralized data repository in communication with said bedside device and configured to receive at least one physiological parameter in the machine-dependent format and convert at least one of the physiological parameters received from the machine-dependent format into a machine-independent format.
